(19) United States
(12) Patent Application Publication
(10) Pub. No.: US 2026/0343712 A1
(43) Pub. Date: Oct. 29, 2026

(54) CONTROL METHOD FOR SWITCHING WORKING MODES OF LIGHTING LAMP AND LIGHTING LAMP

(71) Applicant: Wenjie LI, Guangzhou (CN)

(72) Inventor: Wenjie LI, Guangzhou (CN)

(21) Appl. No.: 19/265,896

(22) Filed: Jul. 10, 2025

(30) Foreign Application Priority Data
Apr. 24, 2025 (CN) 202510523866.9

(51) Int. Cl. H05B 47/17

(52) U.S. Cl. CPC H05B 47/17

(57) ABSTRACT

A control method for switching working modes of lighting lamp and a lighting lamp. The lighting lamp is arranged with a mode switch button corresponding to multiple mode gears, each mode gear corresponds to one lamp working mode, and the control method includes the following steps: obtaining a state of a light source of the lighting lamp, where the state of the light source includes a light-on state; obtaining a current mode gear of the mode switch button when the state of the light source is in the light-on state, and determining a current lamp working mode according to the current mode gear of the mode switch button; and, controlling the light source for lighting according to the current lamp working mode.

### CROSS-REFERENCE TO RELATED APPLICATIONS

The present application claims priority to Chinese Patent Application No. 202510523866.9, filed on Apr. 24, 2025, the content of all of which is incorporated herein by reference.

### FIELD

The present disclosure relates to the technical field of outdoor lighting, in particular to a control method for switching working modes of lighting lamp and a lighting lamp.

### BACKGROUND

In order to meet lighting needs of users in different usage scenarios, an outdoor lighting lamp generally has multiple working modes. Users can switch to a corresponding working mode according to a specific usage scenario for better lighting experience.

At present, when switching working modes of an outdoor lighting lamp, methods of using multiple key combinations, plugging and unplugging a power source or a battery, using different power-on methods, using a cable to connect the lighting lamp with a computer (i.e. switching the working modes of the lighting lamp using the computer), setting a Bluetooth module in the lighting lamp (i.e. connecting the lighting lamp with a mobile application using the Bluetooth), etc. are generally used to switch the working modes of the outdoor lighting lamp. Although the above methods for switching the working modes of the lighting lamp can meet users' needs, these methods are complex to operate, have a certain learning threshold, and are inconvenient for outdoor use.

Therefore, the prior art still needs to be improved and developed.

### SUMMARY

In view of the above-mentioned deficiencies of the prior art, the present disclosure provides a control method for switching working modes of lighting lamp and a lighting lamp to solve the problem of the complex operation of the lighting lamp during the working mode switching in the prior art.

The technical schemes of the present disclosure are as follows.

A control method for switching working modes of lighting lamp is disclosed, the lighting lamp is arranged with a mode switch button corresponding to multiple mode gears, each mode gear corresponds to one lamp working mode, and the control method includes the following steps:
obtaining a state of a light source of the lighting lamp, where the state of the light source includes a light-on state;
obtaining a current mode gear of the mode switch button when the state of the light source is in the light-on state, and determining a current lamp working mode according to the current mode gear of the mode switch button; and,
controlling the light source for lighting according to the current lamp working mode.

In some embodiments, the lamp working modes include a long-runtime lighting mode, one lamp working mode corresponding to one mode gear of the multiple mode gears is the long-runtime lighting mode, the lighting lamp is further arranged with a brightness-adjustment button, the lighting lamp is preset with multiple first brightness values corresponding to the long-runtime lighting mode and a first set temperature threshold, a preset light-on duration in the long-runtime lighting mode is a first preset light-on duration, and
when the mode switch button is in the one mode gear corresponding to the long-runtime lighting mode, the step of controlling the light source for lighting according to the current lamp working mode includes the following steps:
obtaining a quantity of press times of the brightness-adjustment button when the brightness-adjustment button is pressed; and,
adjusting to a corresponding first brightness value based on the quantity of press times of the brightness-adjustment button, and adjusting the corresponding first brightness value when a lighting temperature of the lighting lamp is not less than the first set temperature threshold, where each first brightness value corresponds to one of the quantity of press times of the brightness-adjustment button.

In some embodiments, the lamp working modes further comprise a high-performance lighting mode, one lamp working mode corresponding to one mode gear of the multiple mode gears is the high-performance mode, the lighting lamp is further preset with multiple second brightness values corresponding to the high-performance lighting mode and a second set temperature threshold, the second set temperature threshold is greater than the first set temperature threshold, the preset light-on duration in the high-performance lighting mode is a second preset light-on duration, the first preset light-on duration is greater than the second preset light-on duration, and
when the mode switch button is in the one mode gear corresponding to the high-performance lighting mode, the step of controlling the light source for lighting according to the current lamp working mode includes the following steps:
obtaining the quantity of press times of the brightness-adjustment button when the brightness-adjustment button is pressed; and,
adjusting to a corresponding second brightness value based on the quantity of press times of the brightness-adjustment button, and adjusting the corresponding second brightness value when the lighting temperature of the lighting lamp is not less than the second set temperature threshold, where each second brightness value corresponds to one of the quantity of press times of the brightness-adjustment button.

In some embodiments, the lamp working modes further include a transmit mode, one lamp working mode corresponding to one mode gear of the multiple mode gears is the transmit mode, and
when the mode switch button is in the one mode gear corresponding to the transmit mode, the step of controlling the light source for lighting according to the current lamp working mode includes the following step:
blocking a control signal output when the brightness-adjustment button is pressed.

In some embodiments, the lamp working modes further include an automatic light-control mode, one lamp working mode corresponding to one mode gear of the multiple mode gears is the automatic light-control mode, and
when the mode switch button is in the one mode gear corresponding to the automatic light-control mode, the step of controlling the light source for lighting according to the current lamp working mode includes the following steps:
obtaining lighting environment information in real time, where the lighting environment information includes at least current environment brightness; and,
adjusting a lighting parameter of the lighting lamp based on the lighting environment information.

In some embodiments, the lamp working modes further include an exploration lighting mode, one lamp working mode corresponding to one mode gear of the multiple mode gears is the exploration lighting mode, the lighting lamp is further preset with multiple third brightness values corresponding to the exploration lighting mode and an exploration brightness threshold, a minimum value of the multiple third brightness values is not less than the exploration brightness threshold, and
when the mode switch button is in the one mode gear corresponding to the exploration lighting mode, the step of controlling the light source for lighting according to the current lamp working mode includes the following steps:
adjusting a light type projected by the lighting lamp to a first light type, where the first light type is a spotlight type;
obtaining the quantity of press times of the brightness-adjustment button when the brightness-adjustment button is pressed; and,
adjusting to a corresponding third brightness value for lighting based on the quantity of press times of the brightness-adjustment button, where each third brightness value corresponds to one of the quantity of press times of the brightness-adjustment button.

In some embodiments, the lamp working modes further include a cave-exploration lighting mode, one lamp working mode corresponding to one mode gear of the multiple mode gears is the cave-exploration lighting mode, the lighting lamp is further preset with multiple fourth brightness values corresponding to the cave-exploration lighting mode and a cave-exploration brightness threshold, a minimum value of the multiple fourth brightness values is not less than the cave-exploration brightness threshold, and
when the mode switch button is in the one mode gear corresponding to the cave-exploration lighting mode, the step of controlling the light source for lighting according to the current lamp working mode includes the following steps:
adjusting a light type projected by the lighting lamp to a second light type, where the second light type is a mixed light type of a spotlight type and a floodlight type, with a color temperature of medium white light;
obtaining the quantity of press times of the brightness-adjustment button when the brightness-adjustment button is pressed; and,
adjusting to a corresponding fourth brightness value for lighting based on the quantity of press times of the brightness-adjustment button, where each fourth brightness value corresponds to one of the quantity of press times of the brightness-adjustment button.

In some embodiments, the lamp working modes further include a tactical lighting mode, one lamp working mode corresponding to one mode gear of the multiple mode gears is the tactical lighting mode, the lighting lamp is further preset with multiple fifth brightness values corresponding to the tactical lighting mode and a tactical brightness threshold, a maximum value of the multiple fifth brightness values is not greater than the tactical brightness threshold, and
when the mode switch button is in the one mode gear corresponding to the tactical lighting mode, the step of controlling the light source for lighting according to the current lamp working mode includes the following steps:
obtaining a duration of one press time of the brightness-adjustment button, and when the duration of one press time of the brightness-adjustment button is not less than a preset duration, the lighting lamp twinkling periodically;
when the duration of one press time of the brightness-adjustment button is not less than the preset duration, obtaining the quantity of press times of the brightness-adjustment button when the brightness-adjustment button is pressed; and,
adjusting to a corresponding fifth brightness value for lighting based on the quantity of press times of the brightness-adjustment button, where each fifth brightness value corresponds to one of the quantity of press times of the brightness-adjustment button;
or, when the mode switch button is in the one mode gear corresponding to the tactical lighting mode, the step of controlling the light source for lighting according to the current lamp working mode includes the following steps:
obtaining the quantity of press times of the brightness-adjustment button when the brightness-adjustment button is pressed; and,
adjusting to a corresponding fifth brightness value for lighting based on the quantity of press times of the brightness-adjustment button, where each fifth brightness value corresponds to one of the quantity of press times of the brightness-adjustment button.

In some embodiments, the lamp working modes further include a cross-country running lighting mode, one lamp working mode corresponding to one mode gear of the multiple mode gears is the cross-country running lighting mode, the lighting lamp is further preset with multiple color temperature values corresponding to the cross-country running lighting mode, and
when the mode switch button is in the one mode gear corresponding to the cross-country running lighting mode, the step of controlling the light source for lighting according to the current lamp working mode includes the following steps:
adjusting a light type projected by the lighting lamp to a third light type, where the third light type includes a floodlight type and a spotlight type, the floodlight type is a main light type, and the spotlight type is an auxiliary light type;
obtaining the quantity of press times of the brightness-adjustment button when the brightness-adjustment button is pressed; and,
adjusting to a corresponding color temperature value for lighting based on the quantity of press times of the brightness-adjustment button, where each color temperature value corresponds to one of the quantity of press times of the brightness-adjustment button.

A lighting lamp is further disclosed, including:
a lamp body; and,
a control module, arranged in the lamp body, and configured to execute the control method for switching working modes of lighting lamp as described above.

Beneficial effects of the present disclosure:

A control method for switching working modes of lighting lamp and a lighting lamp are disclosed in the present disclosure, the lighting lamp is arranged with a mode switch button corresponding to multiple mode gears, each mode gear corresponds to one lamp working mode, and the control method includes the following steps: obtaining a state of a light source of the lighting lamp, where the state of the light source includes a light-on state; obtaining a current mode gear of the mode switch button when the state of the light source is in the light-on state, and determining a current lamp working mode according to the current mode gear of the mode switch button; and, controlling the light source for lighting according to the current lamp working mode. In the technical schemes of the present disclosure, when switching the lamp working modes, the mode switch button can be switched to different mode gears to achieve switching the lamp working modes, making the operation simple and convenient, lowering the learning threshold, and facilitating outdoor use.

### BRIEF DESCRIPTION OF THE DRAWINGS

In order to provide a clearer explanation of the technical schemes in the embodiments of the present disclosure or in the prior art, a brief description is given to the accompanying drawings required for the description of the present embodiments or the prior art. Obviously, the accompanying drawings are only some embodiments of the present disclosure. For those ordinary skilled in the art, other drawings can be obtained based on the accompanying drawings without any creative labor.

FIG. 1 is a flowchart of a control method for switching working modes of lighting lamp in the present disclosure.

FIG. 2 is a flowchart of a long-runtime lighting mode in an embodiment of the present disclosure.

FIG. 3 is a flowchart of a high-performance lighting mode in an embodiment of the present disclosure.

FIG. 4 is a flowchart of a transmit mode in an embodiment of the present disclosure.

FIG. 5 is a flowchart of an automatic light-control mode in an embodiment of the present disclosure.

FIG. 6 is a flowchart of an exploration lighting mode in an embodiment of the present disclosure.

FIG. 7 is a flowchart of a cave-exploration lighting mode in an embodiment of the present disclosure.

FIG. 8 is a flowchart of a tactical lighting mode in an embodiment of the present disclosure.

FIG. 9 is a flowchart of the tactical lighting mode in another embodiment of the present disclosure.

FIG. 10 is a flowchart of a cross-country running lighting mode in an embodiment of the present disclosure.

### DETAILED DESCRIPTION OF THE EMBODIMENTS

In order to make a clearer understanding of the technical features, objectives, and effects of the present disclosure, the embodiments of the present disclosure are described in detail below with reference to the accompanying drawings. In the following description, it should be understood that the directional or positional relationships indicated by “front”, “rear”, “up”, “down”, “left”, “right”, “vertical”, “horizontal”, “top”, “bottom”, “inside”, “outside”, “head”, “tail”, etc. are based on the directional or positional relationships shown in the accompanying drawings, constructed and operated in specific orientations, only for the convenience of describing the present technical schemes, and do not indicate that the devices or components referred to must have a specific orientation, and therefore cannot be understood as a limitation of the present disclosure.

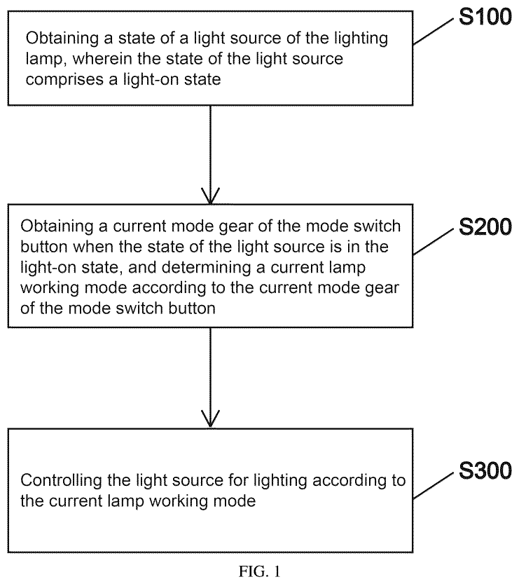

The present disclosure provides a control method for switching working modes of lighting lamp. The lighting lamp is arranged with a mode switch button corresponding to multiple mode gears. Each mode gear corresponds to one lamp working mode. The lamp working modes may include a long-runtime lighting mode, a high-performance lighting mode, a transmit mode, an automatic light-control mode, an exploration lighting mode, a cave-exploration lighting mode, a tactical lighting mode, and a cross-country running lighting mode. As shown in FIG. 1, the control method for switching working modes of the lighting lamp includes the following steps:

S100, obtaining a state of a light source of the lighting lamp, the state of the light source includes a light-on state;

S200, obtaining a current mode gear of the mode switch button when the state of the light source is in the light-on state, and determining a current lamp working mode according to the current mode gear of the mode switch button; and,

S300, controlling the light source for lighting according to the current lamp working mode.

The lighting lamp is arranged with a control module. A switch state of the light source of the lighting lamp is obtained through the control module, and the state of the light source is determined based on the switch state of the light source. The state of the light source includes the light-on state and a light-off state. When the switch state of the light source is in a turn-on state, it indicates that the light source of the lighting lamp is in the light-on state. Conversely, when the switch state of the light source is in a turn-off state, it indicates that the light source of the lighting lamp is in the light-off state.

Furthermore, when the state of the light source is in the light-on state, the control module obtains the current mode gear of the mode switch button of the lighting lamp, and determines the current lamp working mode based on the current mode gear. After the lamp working mode is determined, the control module controls the light source to light based on the current lamp working mode.

In this embodiment, when switching the lamp working modes, the mode switch button can be switched to different mode gears to achieve switching the lamp working modes. The operation is simple and convenient, the learning threshold is low, and it facilitates outdoor use.

In some embodiments, one lamp working mode corresponding to one mode gear of the multiple mode gears is the long-runtime lighting mode. The lighting lamp is further arranged with a brightness-adjustment button, and is preset with multiple first brightness values corresponding to the long-runtime lighting mode. The lighting lamp is preset with a first set temperature threshold.

As shown in FIG. 2, when the mode switch button is in the one mode gear corresponding to the long-runtime lighting mode, the step of controlling the light source for lighting according to the current lamp working mode includes the following steps:

S301, obtaining a quantity of press times of the brightness-adjustment button when the brightness-adjustment button is pressed; and,

S302, adjusting to a corresponding first brightness value based on the quantity of press times of the brightness-adjustment button, and adjusting the corresponding first brightness value when working temperature of the lighting lamp is not less than the first set temperature threshold, where each first brightness value corresponds to one of the quantity of press times of the brightness-adjustment button.

The first set temperature threshold is preset in the control module. When collecting the working temperature of the lighting lamp, a temperature sensor can be arranged at the lighting lamp and is configured to transmit a collected temperature value to the control module. Multiple first brightness values are preset in the control module, and each first brightness value has a different brightness value. Each first brightness value corresponds to one of the quantity of press times of the brightness-adjustment button. The press times of the brightness-adjustment button are counted through the control module. For example, when the brightness-adjustment button is pressed once, the light source of the lighting lamp is adjusted to light through the control module based on the first brightness value corresponding to one press time of the brightness-adjustment button. When the brightness-adjustment button is pressed twice, the light source of the lighting lamp is adjusted to light through the control module based on the first brightness value corresponding to two press times of the brightness-adjustment button.

In applications, when the long-runtime lighting mode is required, users can switch the lighting lamp to the long-runtime lighting mode through the mode switch button. After entering the long-runtime lighting mode, users can further adjust the brightness values of the light source through the brightness-adjustment button, i.e. switching different first brightness values for lighting through the brightness-adjustment button. During the operation of the lighting lamp, the working temperature of the lighting lamp changes with the change of working duration. When the working temperature of the lighting lamp is not less than the first set temperature threshold, the light source of the lighting lamp is adjusted through the control module to continue lighting with a brightness value less than the current first brightness value, in order to achieve long runtime.

In the long-runtime lighting mode, the lighting lamp has a preset lighting duration, which is a first preset lighting duration. When the lighting lamp is in the long-runtime lighting mode, the lighting lamp lights up according to the first preset lighting duration.

It should be noted that the value of the first set temperature threshold can be determined by those skilled in the art according to actual needs, and there is no excessive limitation here.

In some embodiments, one lamp working mode corresponding to one mode gear of the multiple mode gears is the high-performance lighting mode. The lighting lamp is further preset with multiple second brightness values corresponding to the high-performance lighting mode. The lighting lamp is preset with a second set temperature threshold greater than the first set temperature threshold. In the high-performance lighting mode, the lighting lamp has a preset lighting duration, which is a second preset lighting duration. When the lighting lamp is in the high-performance lighting mode, the lighting lamp lights up according to the second preset lighting duration, where the first preset lighting duration is greater than the second preset lighting duration.

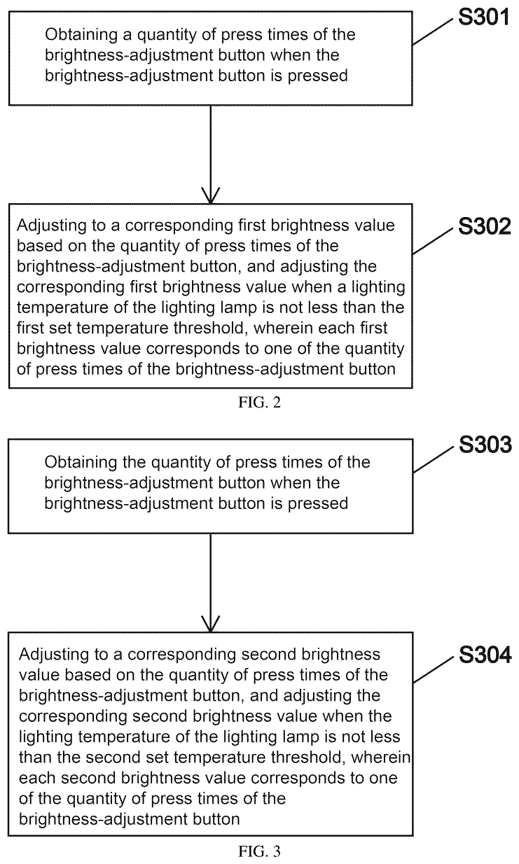

As shown in FIG. 3, when the mode switch button is in the mode gear corresponding to the high-performance lighting mode, the step of controlling the light source for lighting according to the current lamp working mode includes the following steps:

S303, obtaining a quantity of press times of the brightness-adjustment button when the brightness-adjustment button is pressed; and,

S304, adjusting to a corresponding second brightness value based on the quantity of press times of the brightness-adjustment button, and adjusting the corresponding second brightness value when the working temperature of the lighting lamp is not less than the second set temperature threshold, where each second brightness value corresponds to one of the quantity of press times of the brightness-adjustment button.

The second set temperature threshold is preset in the control module. When collecting the working temperature of the lighting lamp, the temperature sensor can be arranged at the lighting lamp and is configured to transmit the collected temperature value to the control module. The multiple second brightness values are preset in the control module, and the each second brightness value has the different brightness value. The each second brightness value corresponds to one of the quantity of the press times of the brightness-adjustment button. The press times of the brightness-adjustment button are counted through the control module. For example, when the brightness-adjustment button is pressed once, the light source of the lighting lamp is adjusted to light through the control module based on the second brightness value corresponding to one press time of the brightness-adjustment button. When the brightness-adjustment button is pressed twice, the light source of the lighting lamp is adjusted to light through the control module based on the second brightness value corresponding to two press times of the brightness-adjustment button.

In applications, when the high-performance lighting mode is required, users can switch the lighting lamp to the high-performance lighting mode through the mode switch button. After entering the high-performance lighting mode, users can further adjust the brightness values of the light source through the brightness-adjustment button, i.e. switching different second brightness values for lighting through the brightness-adjustment button. During the operation of the lighting lamp, the working temperature of the lighting lamp changes with the change of working duration. When the working temperature of the lighting lamp is not less than the second set temperature threshold, the light source of the lighting lamp is adjusted through the control module to continue lighting with a brightness value less than the current second brightness value.

In this embodiment, in the high-performance lighting mode, the brightness values of the light source will only be adjusted when the working temperature of the lighting lamp is greater than or equal to the second set temperature threshold, so that the lighting lamp can maintain high brightness (high brightness refers to that the lighting brightness value during lighting is greater than the brightness value of the light source adjusted when the working temperature is greater than or equal to the second set temperature threshold) lighting for a long time.

It should be noted that the value of the second set temperature threshold can be determined by those skilled in the art according to actual needs, and there is no excessive limitation here.

In some embodiments, one lamp working mode corresponding to one mode gear of the multiple mode gears is the transmit mode.

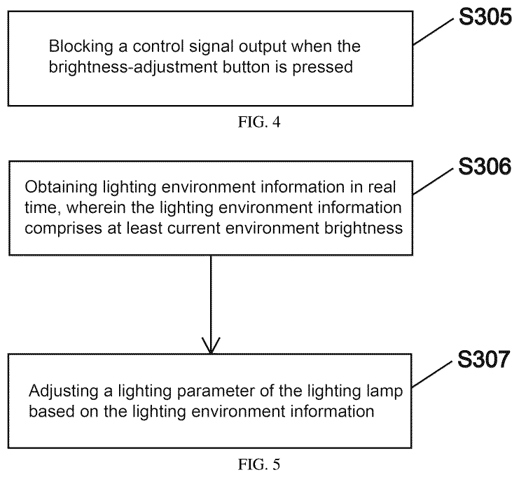

As shown in FIG. 4, when the mode switch button is in the mode gear corresponding to the transmit mode, the step of controlling the light source for lighting according to the current lamp working mode includes the following step:

S305, blocking a control signal output when the brightness-adjustment button is pressed.

When the transmit mode is required, users can switch the lighting lamp to the transmit mode through the mode switch button. After entering transmit mode, the control module automatically blocks the control signal output when the brightness-adjustment button is pressed, i.e. in the transmit mode, the brightness value of the light source is not adjusted, thereby avoiding the lighting lamp automatically adjusting the brightness and ensuring the lighting stability.

In some embodiments, one lamp working mode corresponding to one mode gear of the multiple mode gears is the automatic light-control mode.

As shown in FIG. 5, when the mode switch button is in the mode gear corresponding to the automatic light-control mode, the step of controlling the light source for lighting according to the current lamp working mode includes the following steps:

S306, obtaining lighting environment information in real time, the lighting environment information including at least current environment brightness; and,

S307, adjusting lighting parameters of the lighting lamp based on the lighting environment information.

When lighting is required in the automatic light-control mode, users can switch the lighting lamp to the automatic light-control mode through the mode switch button, while the lighting environment information is obtained in real time through the control module, where the lighting environment information may include but is not limited to the current environment brightness. When the current environment brightness is obtained in real time through the control module, a brightness-collecting sensor can be arranged at the lighting lamp. The brightness-collecting sensor is connected to the control module, and a brightness value (a current environment brightness) collected by the brightness-collecting sensor is transmitted in real time to the control module, i.e. the current environment brightness is obtained through the control module in real time. Furthermore, the control module adjusts a lighting parameter of the lighting lamp based on the real-time collected current environment brightness. The lighting parameter may include but is not limited to brightness, a light type, etc. of the lighting lamp. The lighting parameter that needs to be adjusted can be set by those skilled in the art according to actual needs, and are not overly limited here.

In this embodiment, the automatic adjustment of the lighting parameter of the light source can be achieved in the automatic light-control mode, further improving the user experience.

In some embodiments, one lamp working mode corresponding to one mode gear of the multiple mode gears is the exploration lighting mode. The lighting lamp is further preset with multiple third brightness values and an exploration brightness threshold corresponding to the exploration lighting mode, and a minimum value of the multiple third brightness values is not less than the exploration brightness threshold.

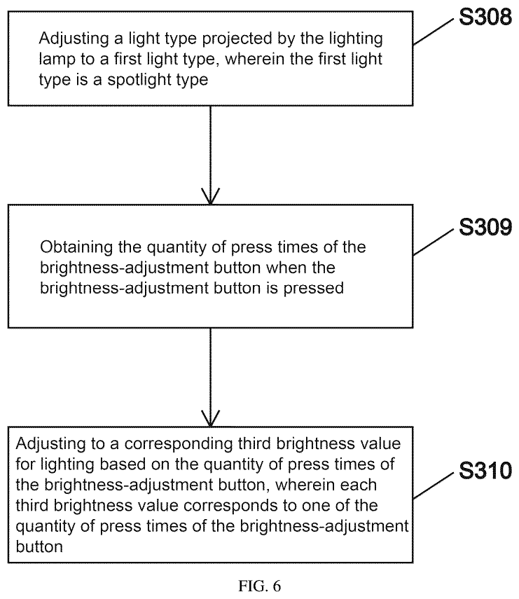

As shown in FIG. 6, when the mode switch button is in the mode gear corresponding to the exploration lighting mode, the step of controlling the light source for lighting according to the current lamp working mode includes the following steps:

S308, adjusting a light type projected by the lighting lamp to a first li type, which is a spotlight type;

S309, obtaining a quantity of press times of the brightness-adjustment button when the brightness-adjustment button is pressed; and,

S310, adjusting to a corresponding third brightness value for lighting based on the quantity of press times of the brightness-adjustment button, where each third brightness value corresponds to one of the quantity of press times of the brightness-adjustment button.

The exploration brightness threshold is preset in the control module. The multiple third brightness values are preset in the control module, and the each third brightness value has the different brightness value. Each third brightness value corresponds to one of the quantity of press times of the brightness-adjustment button. The press times of the brightness-adjustment button are counted through the control module. For example, when the brightness-adjustment button is pressed once, the light source of the lighting lamp is adjusted to light through the control module based on the third brightness value corresponding to one press time of the brightness-adjustment button. When the brightness-adjustment button is pressed twice, the light source of the lighting lamp is adjusted to light through the control module based on the third brightness value corresponding to two press times of the brightness-adjustment button.

When lighting is required in the exploration lighting mode, users can switch the lighting lamp to the exploration lighting mode through the mode switch button, while the control module adjusts the light type projected by the light source of the lighting lamp to the first light type. Afterwards, users can adjust the brightness of the light source by pressing the brightness-adjustment button, and the specific adjustment process is not repeated here.

In this embodiment, due to the exploration brightness threshold in the multiple third brightness values, a minimum brightness requirement can be ensured regardless of how the brightness of the light source is adjusted in the exploration lighting mode.

In some embodiments, one lamp working mode corresponding to one mode gear of the multiple mode gears is the cave-exploration lighting mode. The lighting lamp is further preset with multiple fourth brightness values and a cave-exploration brightness threshold corresponding to the cave-exploration lighting mode, and a minimum value of the multiple fourth brightness values is not less than the cave-exploration brightness threshold.

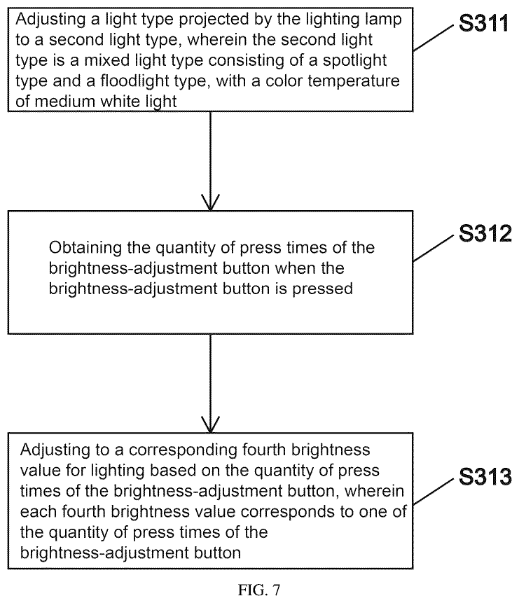

As shown in FIG. 7, when the mode switch button is in the mode gear corresponding to the cave-exploration lighting mode, the step of controlling the light source for lighting according to the current lamp working mode includes the following steps:

S311, adjusting a light type projected by the lighting lamp to a second light type, which is a mixed light type of a spotlight type and a floodlight type, with color temperature of medium white light;

S312, obtaining a quantity of press times of the brightness-adjustment button when the brightness-adjustment button is pressed; and,

S313, adjusting to a corresponding fourth brightness value for lighting based on the quantity of press times of the brightness-adjustment button, where each fourth brightness value corresponds to one of the quantity of press times of the brightness-adjustment button.

The cave-exploration brightness threshold is preset in the control module. Multiple fourth brightness values are preset in the control module, and each fourth brightness value has a different brightness value. Each fourth brightness value corresponds to one of the quantity of press times of the brightness-adjustment button. For example, when the brightness-adjustment button is pressed once, the light source of the lighting lamp is adjusted to light through the control module based on the fourth brightness value corresponding to one press time of the brightness-adjustment button. When the brightness-adjustment button is pressed twice, the light source of the lighting lamp is adjusted to light through the control module based on the fourth brightness value corresponding to two press times of the brightness-adjustment button.

When lighting is required in the cave-exploration lighting mode, users can switch the lighting lamp to the cave-exploration lighting mode through the mode switch button, while the control module adjusts the light type projected by the light source of the lighting lamp to the second light type. Afterwards, users can adjust the brightness of the light source by pressing the brightness-adjustment button, and the adjustment process is not repeated here.

In this embodiment, due to the cave-exploration brightness threshold in the multiple fourth brightness values, the minimum brightness requirement can be ensured regardless of how the brightness of the light source is adjusted in the cave-exploration lighting mode.

In some embodiments, one lamp working mode corresponding to one mode gear of the multiple mode gears is the tactical lighting mode. The lighting lamp is further preset with multiple fifth brightness values and a tactical brightness threshold corresponding to the tactical lighting mode, and a maximum value of the multiple fifth brightness values is not greater than the tactical brightness threshold.

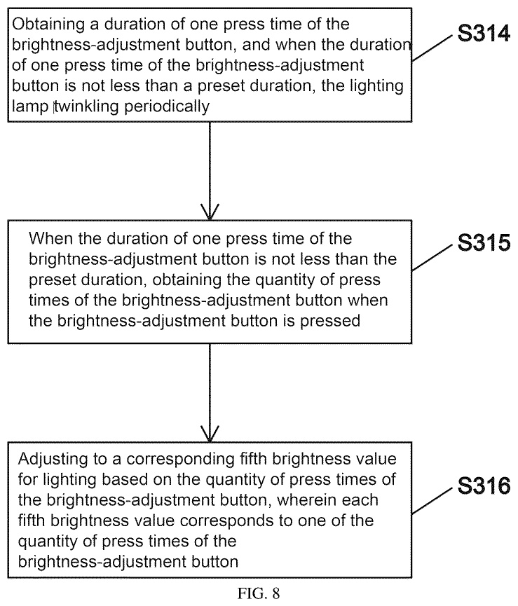

As shown in FIG. 8, when the mode switch button is in the mode gear corresponding to the tactical lighting mode, the step of controlling the light source for lighting according to the current lamp working mode includes the following steps:

S314, obtaining a duration of one press time of the brightness-adjustment button, when the duration of one press time of the brightness-adjustment button is not less than a preset duration, the lighting lamp twinkling periodically;

S315, when the duration of one press time of the brightness-adjustment button is not less than the preset duration, obtaining a quantity of press times of the brightness-adjustment button when the brightness-adjustment button is pressed; and,

S316, adjusting to a corresponding fifth brightness value for lighting based on the quantity of press times of the brightness-adjustment button, where each fifth brightness value corresponds to one of the quantity of press times of the brightness-adjustment button.

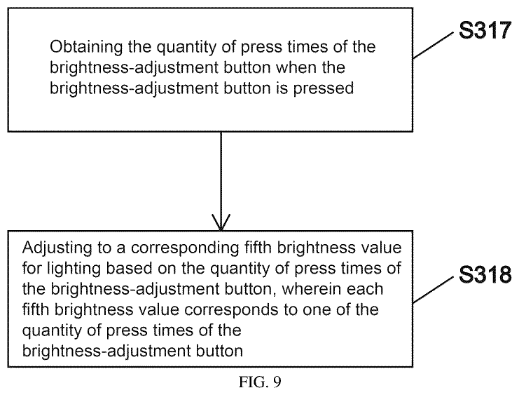

Or, as shown in FIG. 9, when the mode switch button is in the mode gear corresponding to the tactical lighting mode, the step of controlling the light source for lighting according to the current lamp working mode includes the following steps:

S317, obtaining a quantity of press times of the brightness-adjustment button when the brightness-adjustment button is pressed; and,

S318, adjusting to a corresponding fifth brightness value for lighting based on the quantity of press times of the brightness-adjustment button, where the each fifth brightness value corresponds to one of the quantity of press times of the brightness-adjustment button.

The preset duration is preset in the control module, and the tactical brightness threshold is preset in the control module. The multiple fifth brightness values are preset in the control module, and the each fifth brightness value has a different brightness value. Each fifth brightness value corresponds to one of the quantity of press times of the brightness-adjustment button. For example, when the brightness-adjustment button is pressed once, the light source of the lighting lamp is adjusted to light through the control module based on the fifth brightness value corresponding to one press time of the brightness-adjustment button. When the brightness-adjustment button is pressed twice, the light source of the lighting lamp is adjusted to light through the control module based on the fifth brightness value corresponding to two press times of the brightness-adjustment button. Furthermore, by continuously pressing the brightness-adjustment button (the duration of pressing the brightness-adjustment button is not less than the preset duration, and is timed by the control module when the brightness-adjustment button is pressed), the light source can light periodically in a twinkling manner.

In applications, when lighting is required in the tactical lighting mode, users can switch the lighting lamp to the tactical lighting mode through the mode switch button. After entering the tactical lighting mode, the brightness value of the light source can be further adjusted through the brightness-adjustment button, i.e. different fifth light brightness values can be switched for lighting through the brightness-adjustment button. Furthermore, when the light source needs to light in a twinkling manner, the brightness-adjustment button can be continuously pressed to make the light source light in a twinkling manner. Of course, when the light source lights in a twinkling manner, the light source can be adjusted to different brightness values by pressing the brightness-adjustment button for lighting.

In some embodiments, one lamp working mode corresponding to one mode gear of the multiple mode gears is the cross-country running lighting mode. The lighting lamp is further preset with multiple color temperature values corresponding to the cross-country running lighting mode.

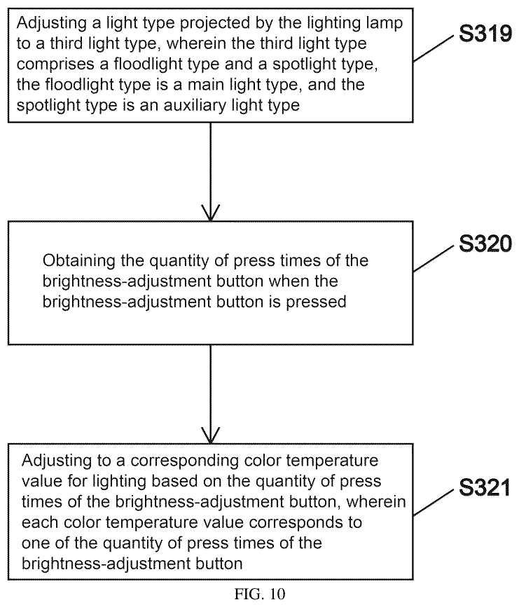

As shown in FIG. 10, when the mode switch button is in the mode gea corresponding to the cross-country running lighting mode, the step of controlling the light source for lighting according to the current lamp working mode includes the following steps:

S319, adjusting a light type projected by the lighting lamp to a third light type, which includes a floodlight type and a spotlight type and, where the floodlight type is a main light type and the spotlight type is an auxiliary light type;

S320, obtaining a quantity of press times of the brightness-adjustment button when the brightness-adjustment button is pressed; and,

S321, adjusting to a corresponding color temperature value for lighting based on the quantity of press times of the brightness-adjustment button, where each color temperature value corresponds to one of the quantity of press times of the brightness-adjustment button.

The multiple color temperature values are preset in the control module. When lighting is required in the cross-country running lighting mode, users can switch the lighting lamp to the cross-country running lighting mode through the mode switch button, while the control module adjusts the light type projected by the light source of the lighting lamp to the third light type. Afterwards, users can adjust the color temperature of the light source by pressing the brightness-adjustment button. The each color temperature value is different and corresponds to one of the quantity of press times of the brightness-adjustment button. For example, when the brightness-adjustment button is pressed once, the light source of the lighting lamp is adjusted to light through the control module based on the color temperature value corresponding to one press time of the brightness-adjustment button. When the brightness-adjustment button is pressed twice, the light source of the lighting lamp is adjusted to light through the control module based on the color temperature value corresponding to two press times of the brightness-adjustment button.

In this embodiment, in the cross-country running lighting mode, the color temperature value of the light source of the lighting lamp can be adjusted through the brightness-adjustment button, without the need for a separate button, thereby reducing costs and making the structure of the lighting lamp more compact and lightweight.

In some embodiments, the present disclosure further provides a lighting lamp including a lamp body and a control module. The control module is arranged in the lamp body and is configured to execute the control method for switching working modes of lighting lamp as described above.

In this embodiment, the control module may be a circuit structure built with a single-chip microcomputer as a core unit to achieve the above functions. Those skilled in the art can determine the circuit structure of the control module according to the actual situations, and there is no excessive limitation here.

It should be noted that the description of the embodiments of the above lighting lamp is similar to the description of the embodiments of the above control method for the lighting lamp, and has similar beneficial effects. For the technical details not disclosed in the embodiments of the present lighting lamp, please refer to the description of the embodiments of the control method for the present lighting lamp of the present disclosure for understanding.

In summary, the present disclosure provides a control method for switching working modes of lighting lamp and a lighting lamp, having the following beneficial effects: when switching the lamp working modes, the mode switch button can be switched to different mode gears to achieve the switching of the lamp working modes, with simple and convenient operation, low learning threshold, and easy outdoor use.

It can be understood that the above embodiments are only the preferred embodiments of the present disclosure, and their descriptions are more specific and detailed, but should not be understood as limiting the scope of the present disclosure. It should be noted that for those ordinary skilled in the art, without departing from the concepts of the present disclosure, the above technical features can be freely combined, and several modifications and improvements can be made, all of which are within the protection scope of the present disclosure. Therefore, any equivalent transformations and modifications made to the scope of the claims of the present disclosure shall fall within the scope of the claims of the present disclosure.

What is claimed is:

1. A control method for switching working modes of lighting lamp, wherein the lighting lamp is arranged with a mode switch button corresponding to multiple mode gears, each mode gear corresponds to one lamp working mode, and the control method comprises steps of:
obtaining a state of a light source of the lighting lamp, wherein the state of the light source comprises a light-on state;
obtaining a current mode gear of the mode switch button when the state of the light source is in the light-on state, and determining a current lamp working mode according to the current mode gear of the mode switch button; and
controlling the light source for lighting according to the current lamp working mode.

2. The control method for switching working modes of lighting lamp according to claim 1, wherein the lamp working modes comprise a long-runtime lighting mode, one lamp working mode corresponding to one mode gear of the multiple mode gears is the long-runtime lighting mode, the lighting lamp is further arranged with a brightness-adjustment button, the lighting lamp is preset with multiple first brightness values corresponding to the long-runtime lighting mode and a first set temperature threshold, a preset light-on duration in the long-runtime lighting mode is a first preset light-on duration, and when the mode switch button is in the one mode gear corresponding to the long-runtime lighting mode, the step of controlling the light source for lighting according to the current lamp working mode comprises steps of:
obtaining a quantity of press times of the brightness-adjustment button when the brightness-adjustment button is pressed; and
adjusting to a corresponding first brightness value based on the quantity of press times of the brightness-adjustment button, and adjusting the corresponding first brightness value when a lighting temperature of the lighting lamp is not less than the first set temperature threshold, wherein each first brightness value corresponds to one of the quantity of press times of the brightness-adjustment button.

3. The control method for switching working modes of lighting lamp according to claim 2, wherein the lamp working modes further comprise a high-performance lighting mode, one lamp working mode corresponding to one mode gear of the multiple mode gears is the high-performance mode, the lighting lamp is further preset with multiple second brightness values corresponding to the high-performance lighting mode and a second set temperature threshold, the second set temperature threshold is greater than the first set temperature threshold, the preset light-on duration in the high-performance lighting mode is a second preset light-on duration, the first preset light-on duration is greater than the second preset light-on duration, and
when the mode switch button is in the one mode gear corresponding to the high-performance lighting mode, the step of controlling the light source for lighting according to the current lamp working mode comprises the steps of:
obtaining the quantity of press times of the brightness-adjustment button when the brightness-adjustment button is pressed; and
adjusting to a corresponding second brightness value based on the quantity of press times of the brightness-adjustment button, and adjusting the corresponding second brightness value when the lighting temperature of the lighting lamp is not less than the second set temperature threshold,
wherein each second brightness value corresponds to one of the quantity of press times of the brightness-adjustment button.

4. The control method for switching working modes of lighting lamp according to claim 2, wherein the lamp working modes further comprise a transmit mode, one lamp working mode corresponding to one mode gear of the multiple mode gears is the transmit mode, and
when the mode switch button is in the one mode gear corresponding to the transmit mode, the step of controlling the light source for lighting according to the current lamp working mode comprises a step of:
blocking a control signal output when the brightness-adjustment button is pressed.

5. The control method for switching working modes of lighting lamp according to claim 2, wherein the lamp working modes further comprise an automatic light-control mode, one lamp working mode corresponding to one mode gear of the multiple mode gears is the automatic light-control mode, and
when the mode switch button is in the one mode gear corresponding to the automatic light-control mode, the step of controlling the light source for lighting according to the current lamp working mode comprises steps of:
obtaining lighting environment information in real time, wherein the lighting environment information comprises at least current environment brightness; and
adjusting a lighting parameter of the lighting lamp based on the lighting environment information.

6. The control method for switching working modes of lighting lamp according to claim 2, wherein the lamp working modes further comprise an exploration lighting mode, one lamp working mode corresponding to one mode gear of the multiple mode gears is the exploration lighting mode, the lighting lamp is further preset with multiple third brightness values corresponding to the exploration lighting mode and an exploration brightness threshold, a minimum value of the multiple third brightness values is not less than the exploration brightness threshold, and
when the mode switch button is in the one mode gear corresponding to the exploration lighting mode, the step of controlling the light source for lighting according to the current lamp working mode comprises steps of:
adjusting a light type projected by the lighting lamp to a first light type, wherein the first light type is a spotlight type;
obtaining the quantity of press times of the brightness-adjustment button when the brightness-adjustment button is pressed; and
adjusting to a corresponding third brightness value for lighting based on the quantity of press times of the brightness-adjustment button, wherein each third brightness value corresponds to one of the quantity of press times of the brightness-adjustment button.

7. The control method for switching working modes of lighting lamp according to claim 2, wherein the lamp working modes further comprise a cave-exploration lighting mode, one lamp working mode corresponding to one mode gear of the multiple mode gears is the cave-exploration lighting mode, the lighting lamp is further preset with multiple fourth brightness values corresponding to the cave-exploration lighting mode and a cave-exploration brightness threshold, a minimum value of the multiple fourth brightness values is not less than the cave-exploration brightness threshold, and
when the mode switch button is in the one mode gear corresponding to the cave-exploration lighting mode, the step of controlling the light source for lighting according to the current lamp working mode comprises steps of:
adjusting a light type projected by the lighting lamp to a second light type, wherein the second light type is a mixed light type of a spotlight type and a floodlight type, with a color temperature of medium white light;
obtaining the quantity of press times of the brightness-adjustment button when the brightness-adjustment button is pressed; and
adjusting to a corresponding fourth brightness value for lighting based on the quantity of press times of the brightness-adjustment button, wherein each fourth brightness value corresponds to one of the quantity of press times of the brightness-adjustment button.

8. The control method for switching working modes of lighting lamp according to claim 2, wherein the lamp working modes further comprise a tactical lighting mode, one lamp working mode corresponding to one mode gear of the multiple mode gears is the tactical lighting mode, the lighting lamp is further preset with multiple fifth brightness values corresponding to the tactical lighting mode and a tactical brightness threshold, a maximum value of the multiple fifth brightness values is not greater than the tactical brightness threshold, and
when the mode switch button is in the one mode gear corresponding to the tactical lighting mode, the step of controlling the light source for lighting according to the current lamp working mode comprises steps of:
obtaining a duration of one press time of the brightness-adjustment button, and when the duration of one press time of the brightness-adjustment button is not less than a preset duration, the lighting lamp twinkling periodically;
when the duration of one press time of the brightness-adjustment button is not less than the preset duration, obtaining the quantity of press times of the brightness-adjustment button when the brightness-adjustment button is pressed; and
adjusting to a corresponding fifth brightness value for lighting based on the quantity of press times of the brightness-adjustment button, wherein each fifth brightness value corresponds to one of the quantity of press times of the brightness-adjustment button; or
when the mode switch button is in the one mode gear corresponding to the tactical lighting mode, the step of controlling the light source for lighting according to the current lamp working mode comprises steps of:
obtaining the quantity of press times of the brightness-adjustment button when the brightness-adjustment button is pressed; and
adjusting to a corresponding fifth brightness value for lighting based on the quantity of press times of the brightness-adjustment button, wherein each fifth brightness value corresponds to one of the quantity of press times of the brightness-adjustment button.

9. The control method for switching working modes of lighting lamp according to claim 2, wherein the lamp working modes further comprise a cross-country running lighting mode, one lamp working mode corresponding to one mode gear of the multiple mode gears is the cross-country running lighting mode, the lighting lamp is further preset with multiple color temperature values corresponding to the cross-country running lighting mode, and
when the mode switch button is in the one mode gear corresponding to the cross-country running lighting mode, the step of controlling the light source for lighting according to the current lamp working mode comprises steps of:
adjusting a light type projected by the lighting lamp to a third light type, wherein the third light type comprises a floodlight type and a spotlight type, the floodlight type is a main light type, and the spotlight type is an auxiliary light type;
obtaining the quantity of press times of the brightness-adjustment button when the brightness-adjustment button is pressed; and
adjusting to a corresponding color temperature value for lighting based on the quantity of press times of the brightness-adjustment button, wherein each color temperature value corresponds to one of the quantity of press times of the brightness-adjustment button.

10. A lighting lamp, comprising:
a lamp body; and
a control module arranged in the lamp body, the control module configured to execute the control method for switching working modes of lighting lamp according to claim 1.
